(19) United States
(12) Patent Application Publication
(10) Pub. No.: US 2006/0174707 A1
(43) Pub. Date: Aug. 10, 2006

(54) Intelligent valve control methods and systems

(76) Inventor: Jack K. Zhang, Ijamsville, MD (US)

Correspondence Address: Jack Zhang, 11119 Innsbrook Way, Ijamsville, MD, 21754, US

(21) Appl. No.: 11/054,445

(22) Filed: Feb. 9, 2005

(51) Int. Cl. G01N 29/14; G01M 3/24; G05D 7/06

(52) U.S. Cl. 73/592; 73/40.5 A; 702/54; 700/282

(57) ABSTRACT

A method for determining a burst pipe that requires immediate feeding-valve closing using acoustic and/or vibration sensors coupled to the pipe lor detecting signals, a microprocessor for analyzing signals from said sensors in real-time, a memory coupled to said microprocessor for storing data, including digital signatures acoustic and/or vibration signatures, as well as an actuator electrically coupled to said microprocessor and mechanically coupled to said feeding-valve. When the sensor signals match stored leak-signatures or when a persistent sensor signal produces no match, the system of the present invention initiates a valve closing. To improve detection, signals from other sensors, i.e. water sensors, smoke detectors, heat sensors or acoustic/vibration sensors mounted on other pipes are also used. Some of the said systems have IP addresses and can communicate over the Internet or wirelessly with others.

### FIELD OF THE INVENTION

The present invention generally relates to systems designed to detect gas or liquid leaks from pipes in a building or other carrying infrastructure. More specifically, the present invention relates to systems designed to (1) detect water or gas leaks based on analysis of vibration and sound signals along with other information; and (2) automatically shut off a leaking water or gas infrastructure.

### BACKGROUND OF THE INVENTION

Household and commercial building water flooding from water systems costs homeowners, businesses and insurance companies more than $100 million every year in the United States alone. Burst pipes from freezing, broken plumbing fixtures or malfunctioning appliances are common causes for water flooding within buildings.

For example, flooding of laundry rooms is such a common occurrence. It is estimated that the unrestricted flow through the hoses of washing machine reaches 3 gallons per minute or 180 gallons an hour. Clearly, in an unmonitored situation, the flow of water will rapidly overflow to the house structures and cause considerable damages. Similarly, toilets can be a source of flooding as well. If the float valve or seal of flush tank malfunctions, water can spill from within the toilet bowl or refill tank onto the floor.

Burst frozen pipe can cause flooding after thawing. When ice melt away, large quantity of water can exits from a burst section. As most of the pipe is within a building structure, the leak can only be discovered before significant damage is done.

In commercial or school buildings, frozen pipe burst disrupt business and classes, damages valuable documents or equipments. These incidences cause tens of thousands of dollars in losses for each occurrence because there is not effective monitoring technology and services, allowing the water to run off in large amount and soaking the property for a very long time before someone discovered it.

### DESCRIPTION OF THE PRIOR ART

The patent literature also describes a number of systems configured to sense a water leak in a single or multiple areas and to turn off a source of water to the device causing the spill. As water flooding is the most common problem, considerable number of patent disclosures centered on detecting water with electrical currents or moisture that can cause detectable resistance or capacitance change in certain materials.

Leak Detection Methods

The prior arts teach a number of ways for detecting water or other liquid leaks. U.S. Pat. No. 5,190,069 utilizes wires embedded in insulation tape carrying leak detecting liquid sensing elements. Wire wrap on the pipes can be triggered by condensations on pipe on high humidity days that can shut off the system and making the system useless.

U.S. Pat. No. 5,240,022 to Franklin describe an automatic system for stopping the flow of water through a valve upon the detection of a water leak. The system detects leakage electrically by sensing moisture, and then shutting off the supply line in response.

U.S. Pat. No. 5,344,973 to Furr, U.S. Pat. No. 5,345,224, U.S. Pat. No. 5,357,241 to Welsh, Jr. et al., U.S. Pat. No. 4,845,472 to Gorden et al. describes the use of moisture sensors at the low point of a basement, with the input water pipe being shut off by a valve.

U.S. Pat. No. 4,324,268 to Jacobson describes an automatic flood control valve apparatus having a pair of sensing electrodes is extended in two directions to detect water leaks adjacent to two different appliances.

U.S. Pat. No. 6,186,162 is a water shut-off system incorporates a water shut-off valve utilizing a pair of adjacently disposed electrodes, a transmitter and a receiving means. It also uses a temperature sensor for shutting down the valve if temperature falls before 38 Deg-F.

U.S. Pat. No. 5,655,561 teaches a wirelessly connected system with flood detectors having electrodes to be placed in a flood prone area. In the event of a flood, electrically current will pass through water and visible, audible alarm indications, including a buzzer and a user-programmable digital voice will be sounded for identification of the area in which a flood occurs. A receiving unit includes a superheterodyne receiver or a super-regenerative receiver and detector, a tone decoder to prevent false alarms, a battery charger, a solenoid valve for shutting off the flow of water in the event to a leak detected by the transmitting unit, and a freeze-guard circuit using a peltier device to keep the solenoid valve within a temperature range allowing valve operation during freezing weather conditions.

More over, the detections based on moisture or conductive liquid detection method and devices, while useful in places such as in laundry room or basement, has many limitations.

A water supply can be accidentally shut down when a kid spilled a bottle of soda by a moisture sensor because the system does not have the ability to determine whether the liquid is from the water supply system.

A pipe can burst and leaking for a long time before water reaches a moisture sensor, if at all. Because it is often difficult to predict where a water pipe may freeze, malfunction or break in a water supply system or a heating system. So it is ineffective in pipe burst situation as an early warning system.

With moisture wired or wireless detectors, it is not possible to place all around a building with unlimited number of detector. As a result, this method is not suitable for large buildings such as a school.

Worst yet, if a house has sprinkler system connected to water system, the sprinkler activation will trigger water shutdowns in the event of a fire. This limitation can result in loss of property and even life.

Other patents use water-metering device as indicator of flow as in U.S. Pat. No. 4,898,036.

U.S. Pat. No. 5,038,820 disclosed an apparatus using a flow sensor with a lever, partially immersed in water. The lever, which can be moved by flowing water in the pipe, is coupled to a “Hall effect” sensor device. The main functional characteristic of this sensor device is that it will produce an output signal when it comes within a magnetic field of certain strength. The flow of water displaced the lever from a neutral position and resulting in sending an output. A control circuit, which can be preset for different operational modes, receives and processes flow status signals from the flow sensor and provides output signals that control the shutoff valve, so that if continuous flow is detected in the conduit for a time period exceeding a pre-selected time, the shutoff valve will automatically close.

While U.S. Pat. No. 5,038,820 considers the amount to time for a waterflow; it has several limitations that can be inconvenient or harmful. For example, the unit requires professional installation in an existing house by shutting down the water, cutting the existing pipe and install according to each municipality's plumbing code. The unit is fairly bulky that will not fit to a pipe that enters a house close to a wall. Additionally, the unit requires a homeowner to input the longest possible water usage before the unit will shut down. If a guest takes longer showers than the member of the house, the water will shut down regardless. Further more, in the event of a pipe burst when no one is in the house, if the device is preset with 30 minutes before shut off, when the home owner returns the house will be soaked in 30 minutes worth of running water. It lacks the protection demanded in this situation to shut off the water as soon as water leak is detected. Similarly, the water will shut-off when watering the lawn for 30 minutes.

For non-conductive liquid, chemical detections are disclosed in various patent literatures.

U.S. Pat. No. 5,960,807 disclosed an automatically actuated regulation system for a natural gas pipeline having flow control unit, a vibration sensor, a gas flow meter, a trigger unit, and a microprocessor. The microprocessor actuates the flow control unit when two conditions are met. First, there must be a vibration, which surpasses a predetermined threshold. Second, flow in the natural gas pipeline must have increased over the flow rate before the vibration. While vibration signal is used, the vibration is not used in ways to determine the source of a leak.

Shut-Off

U.S. Pat. No. 5,229,750 utilizes a float and solenoid valve combination to control a cut-off in the event of a water leak. U.S. Pat. No. 5,632,302 discloses an overflow protection shut-off device for use with a water heater. U.S. Pat. No. 5,428,347, U.S. Pat. No. 5,229,750, U.S. Pat. No. 5,632,302 and U.S. Pat. No. 5,655,561 additionally disclose the use of solenoid-actuated valves in the water supply line.

U.S. Pat. No. 5,029,605 points out that deposits that accumulate in pipes and valves over a period of time may impede the actuation of solenoid-type valves. U.S. Pat. No. 5,240,022, U.S. Pat. No. 5,240,022 incorporates a ball valve in the water supply line. U.S. Pat. No. 5,334,973 also employs a ball valve controls flow into a hot water tank by using a mechanical drive in conjunction with a multilayer moisture sensor which encases the water tank liner.

Automatic system for effective detection and reporting is especially lacking in commercial buildings. No disclosure was found that addresses a pressing need by a large building to monitor the water, sprinkler and water-radiator system for leaks that can occur in so many places within a typical structure. As there can be many branched on many floors in these buildings, a need exist for an cost-effective and reliable system to automatically monitor the water system in large buildings. In the event of a leak, the desired monitoring system should promptly shut off the system and report the event with possible location information to maintenance over the internet or other communication methods.

There is a need for a monitoring method and system equipped with intelligence to actively monitor a liquid carrying system to detect and accurately determine an occurrence of those liquid flow event most likely causing water damages. Further, there is a need for a system capable of taking timely actions when damaging liquid flow events are determined to have occurred so that liquid can be automatically shut off to minimize the magnitude of damage. Additionally, there is a need for a system capable of performing above-mentioned functions simultaneously and reliably in many sections of a large building. Further more, there is a need for a version of the monitoring method and system capable of attaching to existing valves or liquid regulators in a building without having to replace existing valves. Still further, there is a need for a monitoring method and system that is internet addressable so that information can be efficiently and intelligently communicated to and from the system.

Therefore a first objective for the present invention is to provide an intelligent monitoring system for use with water pipe infrastructures in a large building to enable precise leak monitoring and automatic valve shut-off when leak is detected.

A second objective of the present invention is to provide an intelligent monitoring system for use with water pipe infrastructures in a residential building to enable accurate leak monitoring and automatic valve shut-off when leak is detected.

Another set of set of objectives for the present invention is to provide an intelligent monitoring system that can fit with almost all types of residential water pipe infrastructures to easily enable leak monitoring and automatic valve shut-off when leak is detected in three steps: (1) attaching the components of the monitoring system to pipes connecting to the main shut-off valve, (2) coupling the shut-off lever or handle to valve control module and (3) apply electrical power.

A further objective for the present invention is to provide a monitoring system, each has a unique internet address, that can communicate with other devices and systems over the internet.

### SUMMARY OF THE INVENTION

The present invention addresses at least the above-mentioned needs. Therefore, it is the objective of current invention to provide an intelligent monitoring method and system for active monitoring of a pipe system in a house or other liquid carrying infrastructure to detect and determine the cause of flows by detecting the sound and vibration signals and comparing with known digital profiles associated with known flow events.

Using Sound and Vibration Signal in Detections

In accordance with an aspect of the present invention, a method is provided for detecting and determining the occurrence of an event that is likely to cause water damage. The method comprises monitoring sound and/or vibration occurred in the pipe that carries the liquid, such as water. When liquid flows through pipes and regulating valve, sound and vibration occur. The frequencies of these vibrations spread over a wide range. Some are in human audible range and can be detected by human and microphones. Only instruments can detect other vibration components. Because liquid and/or pipes used to carry liquids are typically good sound and vibration conductors, sound and vibrations can be readily detected by transducers, such as surface microphones and accelerometers, coupled to a pipe or submerged in the liquid. Liquid flow vibration can be differentiated from other vibration when time, frequency and patterns are analyzed. A flow sound tends to have consistent components when analyze over time. Therefore, sound and vibration signal can be useful for monitoring the occurrence of liquid flow of mentionable quantity.

There are many advantages for using sound and vibration in liquid carrying system monitoring. First, the method is safe. Unlike many existing system that uses electrical devices directly coupled to the pipe or water that can be dangerous for electrical shock, vibration detection does not couple dangerous wires to pipe nor water. Second, vibration can be detected non-intrusively to an existing system and convenient method for detecting liquid flow without having to replace existing valves. As explained below, vibration detection is much more accurate in determining damaging leaking versus normal use of water.

Vibration and Sound Signature Generation

In accordance with another aspect of the present invention, a method is provided for detecting and determining the occurrence of an event that is likely to cause water damage. The method comprises extracting a sound or vibration signatures by receiving a signal from vibration transducer or a microphone, digitize the signal, applying mathematical algorithms to digitized signal, obtaining the results during or at the end of algorithm processing with values in time and frequency domain and store the values along with time or frequency information in a memory device for later retrieval.

In accordance with another aspect of the present invention, a method is provided for detecting and determining the occurrence of an event that is likely to cause water damage. The method comprises extracting a sound or vibration signatures at various volumes of steady liquid flow through a know fixture, such as faucets, valves and showerheads, to be connected to a liquid carrying infrastructure, and store them in digital form as signatures of known NORMAL EXITS. This signature can be in time domain or frequency domain or a composite signature with multiple characteristics.

In accordance with another aspect of the present invention, a method is provided for detecting and determining the occurrence of an event that is likely to cause water damage. The method comprises extracting a sound or vibration signatures including the turning-on or shutting-off of a know fixture, such as faucets, valves and showerheads, to be connected to a liquid carrying infrastructure, and store them in digital form as signatures of NORMAL ACTIVITIES. This signature can be in time domain or frequency domain or a composite signature with multiple characteristics.

In accordance with another aspect of the present invention, a method is provided for detecting and determining the occurrence of an event that is likely to cause water damage. The method comprises extracting a sound or vibration signatures at various volumes of steady liquid flow simultaneously through a number of know fixtures, such as faucets, valves and showerheads, to be connected to a liquid carrying infrastructure, and store them in digital form as signatures of NORMAL FLOWS. This signature can be in time domain or frequency domain or a composite signature with multiple characteristics.

In accordance with another aspect of the present invention, a method is provided for detecting and determining the occurrence of an event that is likely to cause water damage. The method comprises extracting a sound or vibration signatures including combinations of NORMAL EXITS, NORMAL ACTIVITIES and NORMAL FLOWS, and store the signature as NORMAL EVENT PROFILE. This signature can be in time domain or frequency domain or a composite signature with multiple characteristics.

In accordance with another aspect of the present invention, a method is provided for detecting and determining the occurrence of an event that is likely to cause water damage. The method comprises extracting a sound or vibration signatures including components of liquid flowing through a know broken pipe or hose, such as a plastic or copper pipe cracked by frozen water, to be connected to a liquid carrying infrastructure, and store them in digital form as signatures of ABNORMAL FLOWS. This signature can be in time domain or frequency domain or a composite signature with multiple characteristics. An ABNORMAL EVENT PROFILE is created by tracking vibration and sound signal during the process when a section burst pipe starting to leak after a thaw. These signatures and profiles have information that is used to estimate a flow rate of a water flow through a leak.

In accordance with another aspect of the present invention, a method is provided for detecting and determining the occurrence of an event that is likely to cause water damage. The method comprises extracting a sound or vibration signatures during the liquid flow takes place in the monitored liquid carrying infrastructure, retrieve signatures in storage, comparing the new signature with digital signatures in memory. Each liquid flow event has discernable vibration signature that can be quantified by instruments. By comparing the detected signatures with NORMAL and ABNORMAL digital signatures, the present invention is able to intelligently and rapidly identify events that are likely to cause damages and take appropriate actions.

For example, when a faucet is turned on, the monitoring system will know that water is flowing and exiting the system through a faucet by matching up the faucet's vibration signatures with those of KNOWN DEVICES. Moreover, the monitoring system in accordance with the present invention knows if the faucet is turned on by a person by matching up the faucet's vibration signatures with those of NORMAL EVENTS.

In accordance with yet another aspect of the present invention, the monitoring system utilizes neural network method to learn and store a new sound or vibration signatures of newly connected devices in a liquid carrying infrastructure being monitored. This allows the system to automatically collect and store new signatures of new additions to a water-carrying infrastructure. For example, after remodeling a house, new fixtures, faucets or tubs can be added. The signatures of these new liquid-regulating devices may not exist in the monitoring system. This method gives the monitoring system ability to adapt to new environment automatically thereby making it convenient to use the system.

In accordance with yet another aspect of the present invention, the monitoring system utilizes a manual mode to learn and store a new sound or vibration signatures of newly connected devices in a liquid carrying infrastructure being monitored. The advantage of collecting new signatures with the manual mode versus other methods, such as neural network, is that the manual mode allows the system to positively create and store a new signature quickly.

In accordance with another aspect of the present invention, a monitoring system of the present invention is continuously monitoring mode to detect and determine the occurrence of an event that is likely to cause water damage.

In accordance with another aspect of the present invention a monitoring system of the present invention only initiates active monitoring mode after detecting certain preset threshold of sound or vibration level to determine the occurrence of an event that is likely to cause water damage.

In accordance with another aspect of the present invention a monitoring system of the present invention periodically initiates active monitoring mode to detect and determine the occurrence of an event that is likely to cause water damage.

In accordance with another aspect of the present invention a monitoring system of the present invention utilizes liquid or moisture sensor signal with vibration signal to determine the occurrence of an event that is likely to cause water damage. For example, a water sensor placed by the washing machine signals excessive amount of water on the floor. While at the same time, there is also vibration in the water pipes indicating water is flowing and vibrating signature points to washing machine being the water exit, it is most likely that water is overflowing the washing machine and water must be shut off. On the other hand, if a water sensor placed by a fire-extinguishing water sprinkler system indicating activated spray from sprinklers. The signal from fire-extinguishing sprinkler water sensor will overrides the shut-off instruction from detection module. In the event that both washing machine water sensor and fire-extinguishing sprinkler water sensor sends signal to a detection module, these signals are prioritized for processing. For example, signals from fire-extinguishing sprinkler water sensor carries a high priority than washing machine water sensor signal. In the event both signals are received within a time window, the detection system will not issue final shut-off command, leaving the valve to stay on.

In accordance with another aspect of the present invention a monitoring system of the present invention utilizes temperature sensor signal with vibration signal to determine the occurrence of an event that is likely to cause water damage. For example, if the indoor temperature has dipped below freezing and a suspicious water flow event occurs, the monitoring system will assign the possibility of a burst frozen pipe to be high.

In accordance with another aspect of the present invention a monitoring system of the present invention utilizes event-timing information with vibration signal to determine the occurrence of an event that is likely to cause water damage. This ability can help to save water. For example, a person left a faucet on when the water was shut off for a water main break and went to work. When the water is back, the faucet will be running for hours before shut off. The monitoring system in accordance with the present invention detects water existing a known faucet without detecting the vibration associated with typical device-turning-on signal registered in a NORMAL EVENT PROFILE for that faucet, will starts timing to see if someone will notice it before long. After a preset time limit is reached, the water is shut off.

In accordance with another aspect of the present invention a monitoring system of the present invention utilizes calendar information with vibration signal to determine the occurrence of an event that is likely to cause water damage. For example, according to the calendar stored in the system, it is winter season. When the monitoring system detect an extended water flow event in a residence, it will determine the likelihood of burst frozen pipe to be high when considering other information in determining possible shut-off.

In accordance with another aspect of the present invention a monitoring system of the present invention utilizes secondary sound or vibration detection modules mounted on another liquid carrying infrastructure with primary vibration signal to determine the occurrence of an event that is likely to cause water damage. For example, when the primary vibration sensor senses liquid flow, if secondary sensors mounted on sewer pipes give clear indication of water flow sound and vibration with correlation to liquid flow in water pipes, then the water flow in the pipes is most likely normal. In another example, when a sound sensor sense fire alarm sound, it is a case that water must remain on regardless of water flow events.

In accordance with another aspect of the present invention a monitoring system of the present invention utilizes multiple sound or/and vibration detection modules mounted in various locations on a liquid carrying infrastructure. These modules are capable of communicating with each other to collectively or individually determine the occurrence of an event that is likely to cause water damage. This embodiment is especially useful in large buildings because the module close to a leak will help the system to have a higher confidence in reporting abnormal liquid flow event. More importantly, the remote modules will provide important information on the proximity of the reported abnormal event. For example, when the vibration detection module senses liquid flow through gating valve, if the remote detection module mounted on branch pipes on the 27^{th} floor of a high rise building detects the strongest vibration signal and the widest range of vibration frequencies than any other detection modules, the data indicate a liquid flow is most likely exiting on that floor. In case the flow is deemed to be abnormal, this data will give maintenance personnel valuable information on where to look for possible water damages in a large building.

Shut-Off and Installations Features

In accordance with another aspect of the present invention, a monitoring system utilizes a universal device that is capable of rapid coupling to existing valve handles or knobs of various form factors associated with shut-off valves in buildings. The couple will transmit torque to a valve's handle or know from an actuator controlled by a monitoring system according to the present invention. The advantage of this embodiment is that leak monitoring and damage control can be introduced to a house conveniently without having to replace, remove or modify existing water carrying infrastructure.

In accordance with another aspect of the present invention, a monitoring system for retrofitting non-automatic shut-off valves, the monitoring system capable of performing abnormal liquid flow detection and automatic shut-off functions comprises a vibration transducer and/or a microphone; a signal processing module including memory, processor, A/D converter and circuitry; a communication module including internet addressable networking circuitry, transceivers for wired or wireless communications; a actuator for shutting valves; a power module comprising batteries and/or AC adapter; a coupling device for transmitting torque from actuator to valve handle; and structure for housing the components.

In accordance with another aspect of the present invention, a monitoring system for new installation as a self-contained valves capable of performing abnormal liquid flow detection and automatic shut-off functions comprises a vibration transducer and/or a microphone; a signal processing module including memory, processor, A/D converter and circuitry; a communication module including internet addressable networking circuitry, transceivers for wired or wireless communications; a actuator for shutting valves; a power module comprising batteries and/or AC adapter; a coupling device for transmitting torque from actuator to valve handle; and structure for housing the components.

In accordance with another aspect of the present invention, a monitoring system multiple detection modules and valve control modules are provided to couple with multiple shut-off valves on the same liquid supply system. Each shut-off is capable of being activated to shut off a section of a liquid supply system in dependent of each other based instructions from the detection modules.

This configuration is most useful for rapidly and positively isolating the location of liquid exit in a large building. For example, if a burst pipe is on the 39^{th} floor of an office building over a weekend. It may take many hours or days before the leak to be discovered and reported. It usually takes up to 30 minutes for the leak to be located and stopped. This can results in tens of thousands dollars in damage.

When a building is equipped with a monitoring system in accordance with this embodiment of the present invention, the detection module identifies the leak as ABNORMAL, reports the leak to maintenance on duty and issues command to the valve control modules to shut-off immediately. The shut-off modules can start by shutting off the section of the pipe closest to the leak. If the leak stops as a result of the shut-off, the vibration signal associated with the leak will stop, which provides the monitoring system with information on approximate location of the leak. Repair personnel can use the information to speed up repair work.

If the section shut-off did not stop the leak, other sections shut-off are initiated. If the vibration signal associated with the leak persists, valve control module at the main shut-off will activate to stop all water supplies. The incident is then reported to the building-monitoring network over the Internet or other communication networks.

Communication Capability

In accordance with another aspect of the present invention, a monitoring system comprises of components, such as detection module, transducers or valve control modules, each having unique network addresses in compliance with industry standards such as Internet Protocol Ipv6. These network addressable components can communicate with each other or other devices over the Internet with connections in wireless, such as WiFi, WiMAN or Bluetooth, and/or wired connection such as LAN or WAN.

In accordance with another aspect of the present invention, a monitoring system includes a wireless transceiver for communication with other detection modules, controllers or communication devices.

In accordance with another aspect of the present invention, a monitoring system receives, generates and/or transmits electrical signals communicating various states the system is in or liquid flow events detected. For example, the system generates an electric signal to be used to activate valve shut-off once a liquid flow through burst pipe is detected. In another instance, the system can send a signal indicating the valve has been shut off.

In accordance with another aspect of the present invention, a monitoring system receives, generates and/or transmits electromagnetic, infrared or light or other wireless signals communicating various states the system is in or liquid flow events detected. For example, the system generates a wireless signal to device to sound an audible alarm once a liquid flow through burst pipe is detected. In another instance, the system can send a wireless signal to a wireless network indicating the valve has been shut off.

In accordance with another aspect of the present invention, a monitoring system receives, generates and/or transmits acoustic signals communicating various states the system is in or liquid flow events detected. For example, the system sounds an audible alarm or a speech warming once a liquid flow through burst pipe is detected. In another instance, the system can send an ultrasound signal to a communication device indicating the valve is on.

In accordance with another aspect of the present invention, a monitoring system receives, generates and/or transmits vibration and/or sound signals communicating through liquid and/or pipe to exchange information between modules. For example, the system can have various detection modules installed on water pipes on different floors in a large building. The communication between the modules is carried out by modulated vibration or sound signals. A base unit can “ping” the remote units to test to ensure they are all functioning well. When a liquid leak is detected, a base unit can, for instance, communicates with each remote unit and ask them to report their detected water flow vibration intensity and signature through modulated sound signals. Likewise, the system can gather location of burst pipe with the help of these remote modules.

There are distinctive advantages of using modulated vibration and sound for communication over the water pipes. First, both base station and remote modules are already equipped with transducers. Second, vibration or sound over water pipes, which typically made of good sound conductor, can travel a long distance from point to point. Third, sound or vibration over pipes is immune to electricity or radio wave interference, thus more reliable and robust.

In accordance with another aspect of the present invention, a monitoring system generates and/or transmits signals over the Internet or a home monitoring system that can be displayed as visual text or graphic information to communicate various states of the system, liquid flow events detected. For example, the system can display the possible leakage over a floors plan for a building with text notations on a screen of a computer at a remote location or the display device of a building monitoring system.

### DESCRIPTION OF DRAWINGS

FIG. 1 is a functional diagram for Detection Module and Valve Control Module in a monitoring system according to the present invention.

FIG. 2a is an illustrative outline of a signal detected by a vibration sensor when a person turns on a faucet.

FIG. 2b shows typical information used to construct a NORMAL EVENT PROFILE in time domain.

FIG. 2c is an example of FFT (Fast Fourier Transformation) of the signal in FIG. 2a.

FIG. 2c shows an example of signal matching in frequency domain using FFT (Fast Fourier Transformation) of the signal in FIG. 2a.

FIG. 3 detailed a typical logic diagram provided by the present invention in determining liquid leaks and initiate shut-off.

FIG. 4 is a component diagram a monitoring system according to the present invention.

### DETAILED DESCRIPTIONS OF THE INVENTION

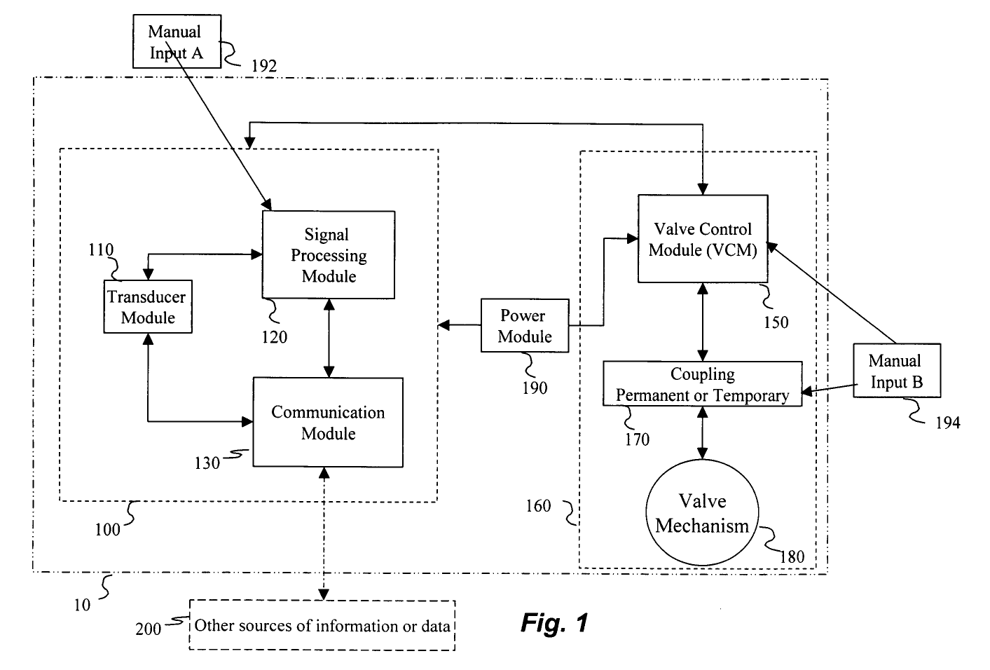

On FIG. 1, a monitoring system 10 according to the present invention is shown to include functional Detection Module (DM) 100. DM 100 comprises a Transducer module 110 for detecting vibration signal. For 110 to function, at least one vibration sensor, an accelerometer or a microphone is provided with appropriate power supply. Most vibration sensors today are either piezoelectric or piezo-resistive. Piezoelectric transducers are typically good for vibrations of higher frequencies, although peizo-film enables measurement of lower frequencies. Piezo-resistive sensors are good for low frequencies, such as MEM accelerometers, are inexpensive and small. Microphones are a variation of the vibration sensor optimized to detect certain frequency range in a structure or over the air. For use with the present inventions, small microphones are preferred. In this disclosure, vibration transducers are used to include terms covered by accelerometers, vibration sensors and microphones regardless specific technologies. In most cases, the output from 110 is a voltage-over-time signal to Signal Processing Module 120.

Signal Processing Module 120 includes an A/D converter, a microprocessor, a memory, and circuitry. The A/D converter is used when the outputs from Transducer Module is an analog signal. It digitizes an analog signal and prepares it for processing by a microprocessor. Some transducers today incorporate an A/D converter within. In this case, the A/D converter can be included with Transducer Module. Regardless, it is a useful component in a system of the present invention. The memory is provided for store data from communication module, intermediate data from the processor, post processing data and various signatures including NORMAL EXIT, NORMAL ACTIVITIES, NORMAL FLOW as well as ABNORMAL EXIT, for comparison during processing. To enable the mentioned components to function, connecting circuitries is provide to establish connections within and to the outside of the module, such as with Communication Module 130.

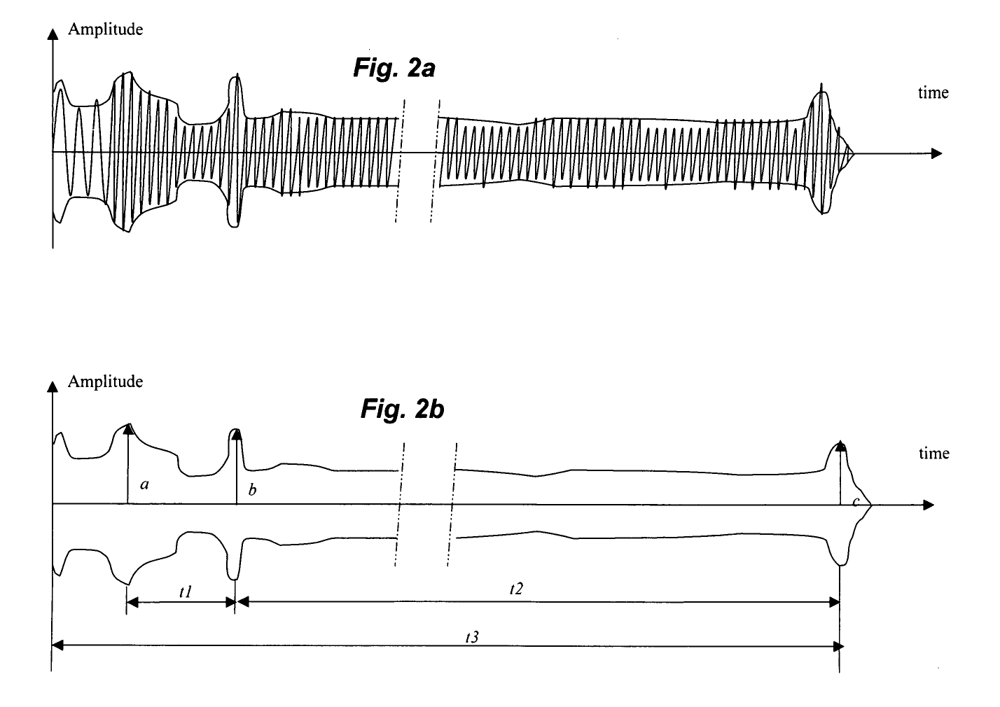

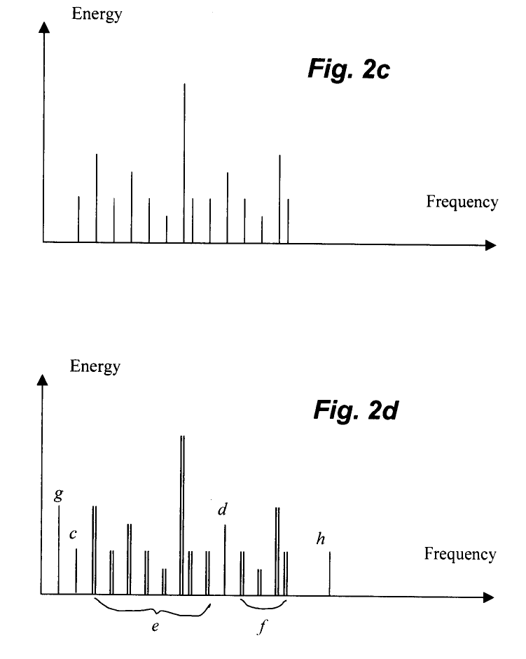

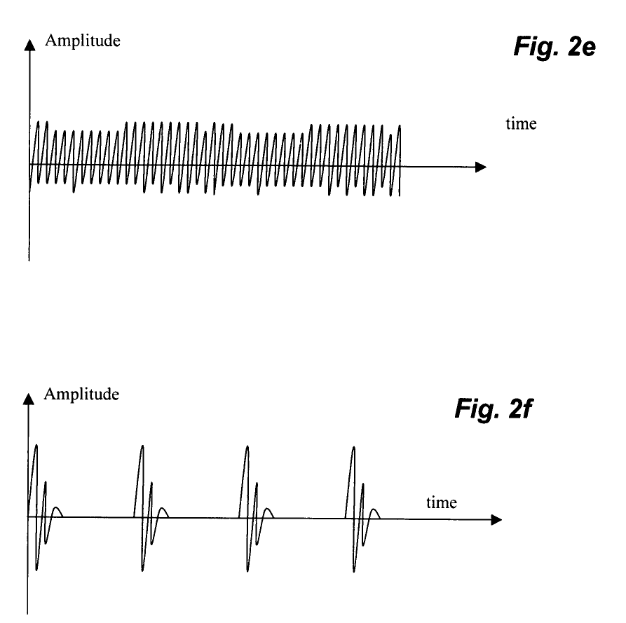

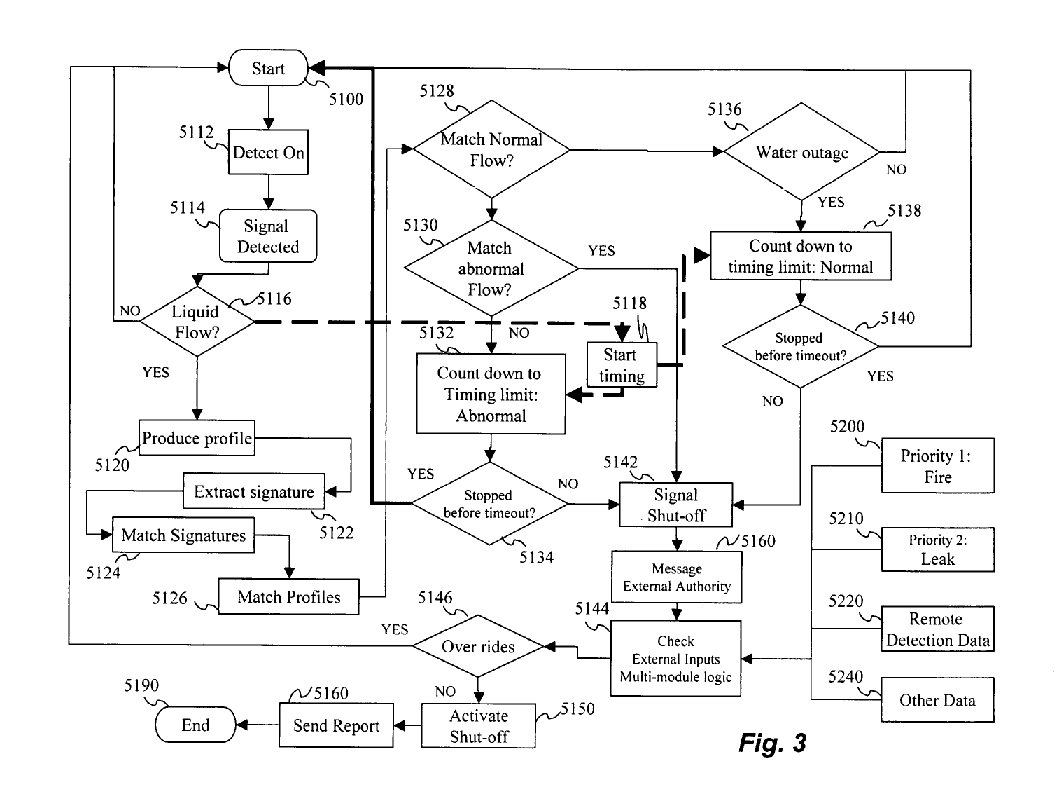

Sound and vibrations signals can be useful in monitoring liquid flow. Because liquid and pipes used to carry liquids are typically good sound and vibration conductors, sound and vibrations can re readily detected by transducers, such as microphones and accelerometers, coupled to a pipe. Liquid flow vibration can be differentiated from other vibration and sound when time, frequency and patterns are analyzed. For example, a common source of vibration detected in water pipe in a household other than water flow is from walking steps on the floor. When analyze over time, the signal from steps shows characteristics as shown in traces in FIG. 2e, while a signal from a steady water flow has a consistent level as shown in FIG. 2f. It is practical to use vibration and sound signals to quickly differentiate the occurrence of a steady liquid flow from other vibration sources.

Manual Input A 192 is provided to Signal Processing Module 120. 192 is provided for several purposes including resetting 120, overriding an instruction, telling 120 to extract and store a signature of a new water faucet connected to the water infrastructure.

Communication Module 130 of the present invention includes at least a circuitry that is Internet network addressable and a transceiver for wired or wireless communications. A network addressable device is most useful when communication is required over a network of prevailing standards such as IP (Internet Protocol). The new Ipv6 enables virtually limitless number of IP addresses. Using a standard such as Ipv6, each Detection Module 100 in accordance with the present invention can have an IP address for communication. There many advantages of a monitoring system using network addressable components including ease of implementation with a growing proliferation of WiFi, WiLAN and WiMAN, timely communication, cost effectiveness due to elimination of data translation equipment and use of standardized equipment, anywhere and anytime remote monitoring over the Internet. The primary function of 130 is to facilitate communication within 100 and externally with information sources such as sensors, and other detection systems 10 for detection of liquid flow in the infrastructure being monitored. A secondary function of 130 to report detection status in the forms of alarm, text or graphic display, triggering security system or post the result on the Internet. A third function of 130 is to take commands sent remotely from authorized party to activate or deactivate monitoring activities. A fourth function of 130 is to take commands sent remotely from authorized party to open or shut-off a valve in a building.

When an Internet addressable Communication Module 120 is connected, wirelessly or via wire, to a Valve Control Module 150, 150 becomes Internet addressable. Valve Control Module 150 comprises an actuator for shutting valves and a circuitry for internal and external connection. And when a Valve Mechanism 180 is coupled, through 170, with a Valve Control Module 150, 180 becomes Internet addressable, enabling 150 to take commands sent remotely from authorized party to open or shut-off valve 180 in a building.

Coupling 170 conveys the force or torque needed to move necessary components in a valve. Typically, the valve can be shut-off by turning a shaft connected to a ball valve. In this case, torque from Valve Control Module 150 is passed on to 180. 170 can be permanent as in an integrated unit 160. Otherwise, 170 can connect 150 to 180 that are separate devices. 170 can be mechanical or electromechanical.

Manual Input 194 is provided for a number of purposes including overriding an action by 150 when 170 is permanent, physically turning on/off 180 when 170 is temporary or testing 150.

System 10 is powered with Power Module 190, comprising batteries and/or AC adapter and circuitries for connection and power management. Batteries can be rechargeable batteries that are charged when the AC power is available. When AC power is out, these rechargeable batteries will provide power for monitoring and communications.

Detection Module (DM) 100 and Signal Processing Module 120 are preferably to operate continuously to enable monitoring capability around the clock. To operate in this mode, an AC power adaptor is included to provide power. When the AC power is out, 100 and 120 will operate in power saving mode. In one embodiment of the current invention, a threshold is set for 100 to send a signal to 120 only when the signal is above certain level. 120 will only enter active mode after determine it is a signal from a constant flow. Otherwise, it will go back to sleep mode. Alternatively, 120 has a clocking signal to wake up the system every 30 seconds to see if there is a vibration or sound signal for a constant flow. If there is one, 120 will enter active mode. Otherwise, the system will go back to sleep for another 30 seconds.

In one embodiment of the present invention designed to retrofit to existing valves in households or a commercial building, Detection Module 100, Valve Control Module 150, Coupling 170 for temporary coupling to the handle of a ball valve and a battery chamber for 190 are made into a single housing.

In another embodiment of the present invention designed to replace to existing manual valves or as valves in new construction, Detection Module 100, Valve Control Module 150, Coupling 170 for permanent coupling, Valve Mechanism 180 and a battery chamber for 190 are made into a single housing.

FIG. 2a to d are examples of how the system of the present invention detects, processes and determines liquid flow in a liquid carrying infrastructure such as the pipes in a house, apartment building or an office high-rise. The activities are primarily in Transducer Module 110 and Signal Processing Module 120.

FIG. 2a show an illustrative trace found on the screen of an Oscilloscope from a vibration sensor mounted on a water pipe when a faucet is turned on. There are three distinctive segments in the traces shown in FIG. 2a. Segment A shows the detected vibration signal when a human hand touches the handle of a faucet, lifting of the handle and opening of valve in the faucet. Segment B registers the signal from vibration of faucet valve and pipe caused by a steady stream of water flowing through the opening of the faucet's valve. Segment C depicts the vibration detected when a human hand shutting down the faucet. A peak coincides with the impact of valve parts when a valve closes.

Due to unique designs, construction and material for a specific model of plumbing device, such as a faucet or a valve, there is a distinguishable trace for each type of device. More particularly, when a valve is opened, there is a relatively consistent proportion to the magnitude of signal detected. For example, as shown in FIG. 2b, for dominant peaks present during all valve openings, the value a/b stays in a fairly narrow range or remain constant. In addition, during most openings, t1 is relatively consistent. Similarly, if the same person who turned on a faucet, the peak value of signal c for shutting off the valve has a correlation with the other values, a and b. That is, a/c and b/c for multiple valve open-close sessions for normal use by the same person stay in the consistent rang as observed. These values are used in time domain signatures for identifying a device is turned on. As both the speed and the strength of a person using a valve is relatively consistent, it is also possible to identify which regular user of a water system turned on a faucet.

These signatures and profiles have information that is used to estimate a flow rate of a water flow by analyzing the magnitude of the signal detected. Because most water infrastructure has a stable pressure. The rate of flow is proportional to the size of an opening from which the liquid exits. The level of vibration of a given exit is proportional to the amount of liquid flowing through. The same principle is used in the present invention in detecting the projecting potential damages from a leak.

In FIG. 2b, where the outline of the trace is FIG. 2a is shown for clarity, t3 is the total time between the times when the faucet is opened to the moment the faucet is completely shut-off. Time t3 is referred in this disclosure as “Event duration”. Time t2, herein referred as “steady flow duration”, is the time when the faucet is turned on and water is running at a steady flow before the faucet began to shut off.

For most water devices in a building, t2, when statistically analyzed, follows a distribution pattern over a probability. In addition, t2 follows a usage pattern when plotted against time of a day, a week, a month or a year. The present invention utilizes all information identified in the process of determining a possible leak.

In addition to information in time domain, analysis of a trace in frequency domain reveals further information useful in monitoring a liquid carrying infrastructure such as a water pipe system. For instance, Fast Fourier Transformation, or FFT, is performed on the trace in FIG. 2b including time windows t2, the results can be shown in a graph found in FIG. 2c. FFT is a way to show the energy present in the trace of FIG. 2a at each frequency. It is observed that for each water device, the FFT graph from a trace in time domain such as that of FIG. 2a demonstrates unique and identifiable features each time the water flows through the device. These FFT features includes the peaks, E1 and E2 corresponding to a particular frequency (positions of peaks), and a identifiable ratios (FFT profile) as expressed in E3/E1, E4/E2 or E1/E2. These FFT features are used to extract frequency domain signatures to identify which faucet has water running through as detected.

Using data in vibration and sound signals, a set of information, herein referred to as signature in the present invention disclosure, can be identified that are both unique and representative of an event of interest. The process and method of obtaining the signature comprises extracting a sound or vibration signatures by receiving a signal from a transducer or a microphone, digitize the signal, applying mathematical algorithms to digitized signal, obtaining the results during or at the end of algorithm processing with values in time and frequency domain and store the values along with time or frequency information in a memory device for later retrieval.

In order to isolate leak in a liquid carrying infrastructure, the monitoring system must first be capable of identify signals from normal points of liquid exits, such as faucets, valves and showerheads connected to a liquid carrying infrastructure for use by users of the infrastructure. These signatures of NORMAL EXITS (NE) include both time domain information of a NE.

NE signatures are created using sound or vibration signals at various volumes of steady liquid flow through an NE, as shown in FIG. 2a, including frequency, trace shape and amplitudes of time domain signal during t2, as well FFT profiles and peak energy shown in FIG. 2c. When a liquid flow bares a clear NE signature match, a monitoring system can pinpoint the flow to a known NE with a high degree of certainty.

In order to isolate leak in a liquid carrying infrastructure, the monitoring system must second be capable of identify signals from NORMAL ACTIVITY (NA) of NE points of a liquid carrying infrastructure by users. These NORMAL ACTIVITIES include turning-on or shutting-off of a NE fixture, such as faucets, valves and showerheads, to be connected to a liquid carrying infrastructure. As discussed earlier, by applying mathematically algorithm to the segment as shown in FIG. 2a during t1 for turning on and during t3 for shutting-off, for example, data set representing a specific model of faucet can be obtained in time or frequency domain and stored in digital form as NA signatures.

Due to uniqueness in each liquid carrying infrastructure, there are vibration and sound characteristics associated to each infrastructure. The present invention employs neural network method. A monitoring system according to the present invention, in addition to signatures stored before deployment, will “learn” new vibration and sound signatures after the system is installed to a liquid carrying infrastructure. Each time when a liquid flow occurs, the system will extract a signature in ways described above and store it while at the same time monitoring the infrastructure for possible abnormal liquid flows is useful because it enables a monitoring system of the present invention to successfully adapt to each liquid carrying infrastructure. This capability also allows a monitoring system of the present invention to recognize changes, such a addition of new faucet, without confusing a flow through that faucet with a leak.

In a liquid carrying infrastructure each time liquid is used, there are likely to be more than one fixture, such as water meter, faucets, valves and showerheads, for liquid to pass through to reach an NE. At times, liquid can flow through more than one NE simultaneously. Using processes described above, various signatures for steady flows are extracted from segments of traces corresponding to t2 in FIG. 2a and stores in digital form as signatures of NORMAL FLOWS (NF). An NF signature is essentially a compounded signature of NA or NE with other added components such as pipe vibration signatures. The signature can be in time domain or frequency domain or a composite signature with multiple characteristics.

Pipe vibration signal is useful in locating the leak in case of burst pipes.

As illustrated in FIG. 2a and 2b, a normal flow of liquid causes a series of detectable signals marked by t1, t2 and t3, each segment can form a signature, both in time and frequency domain, that are independently useful for identify liquid flows. These signatures can be used in tandem to increase the certainty when identifying a liquid flow. For example, if a sound or vibration signal, when processed matches the signatures of NE, NA and NF, of a showerhead, the monitoring system can be highly confident about not sounding an alarm. The combined signatures of NE, NA and NF are referred to as NORMAL EVENT PROFILE (NEP).

On the other hand, there are known forms of leaks in liquid carrying infrastructures. For example, burst pipes from freezing are leading causes of leak during wintertime. There are very limited types of materials approved for water pipes in residential and commercial buildings, i.e., plastics, copper, regular steel and stainless steel. Additionally, there is a limited number of commercially available diameters and thickness for these pipes. By fitting each one of these pipes with vibration and sound transducers, connecting them to municipal water supply, subjecting the pipes to freezing conditions, then thaw the ice in the pipe, one can simulate the leaking and measure signals from the transducers while the leak takes place. Signatures can be created from the signal by applying algorithms for each pipe size, thickness and material. These signatures are referred to as signatures of ABNORMAL FLOWS (AF). This signature can be in time domain or frequency domain or a composite signature with multiple characteristics. By storing AF signatures, a monitoring system of the present invention is capable of positively identify damaging events such as a burst pipe leak after a thaw.

The present invention also uses vibration and sound information immediately prior to an AF to create an ABNORMAL EVENT PROFILE (AEP). For instance, when an earthquake takes place, the shock will cause a water pipe or a gas line to rupture. The signal of rupture immediately precedes a leak of gas or water. By using AEP, a monitoring system of the present invention is capable of determine leaks caused by natural disasters such as earthquake.

FIG. 2d illustrates an FFT signature is overlaid on FFT detected by a monitoring system of the present invention during a signal processing session in determining possible leaks. Typically, the vibration and sound signal and resulting signature from a faucet connected to a liquid carrying infrastructure is slightly different from the signature stored in a monitoring system because there are many more other pipes and fixtures connected. The structure the pipes are installed to also affects the signals from which an FFT is performed. For example, in FIG. 2d, component g, h, and j were not in the signature shown in FIG. 2c. The newer signature did not have components e and f, possibly due to the way a faucet is mounted. However, the majority of components in bracket “e” and “f” match with signatures in memory, indicating an identification of high degree of certainty.

As an objective of the present invention is to detect leaks, often AF and AEP signatures are matched in similar fashion as described above. Each liquid flow event has discernable vibration signature that can be quantified by instruments. By comparing the detected signatures with NORMAL and ABNORMAL digital signatures, the present invention is able to intelligently and rapidly identify events that are likely to cause damages and take appropriate actions. It is not hard to see that the same techniques can be applied to natural gas lines in a house, or a tanker.

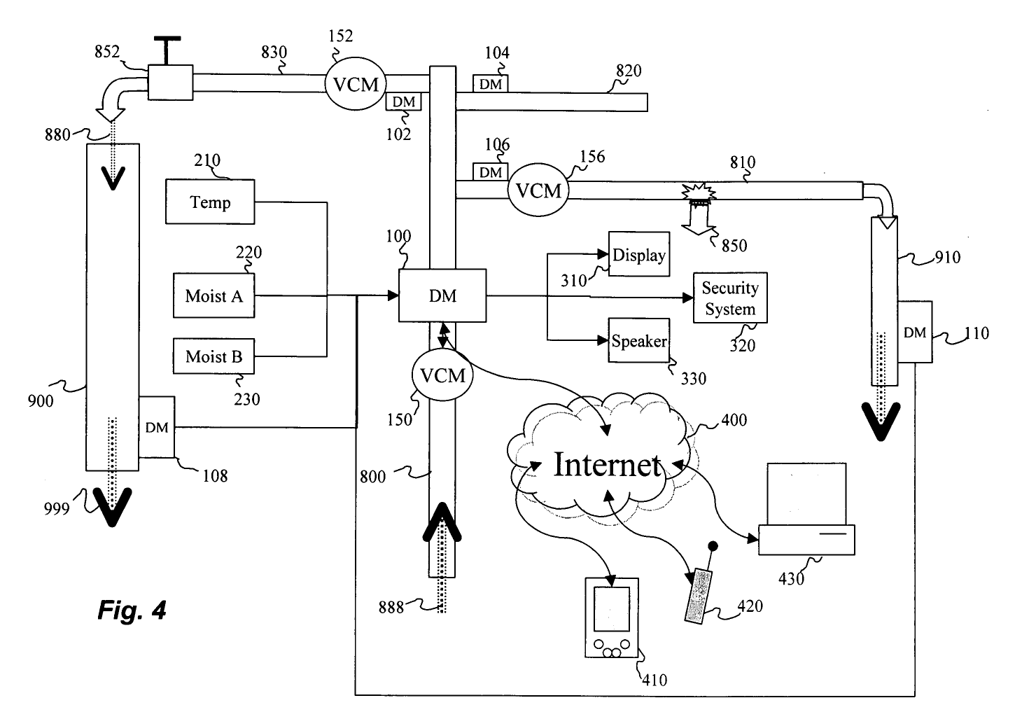

In FIG. 3, an example for processing diagram is shown for determining possible liquid leak and issuing command to shut off and leaking liquid carrying infrastructure.

Referring to both FIG. 1 and FIG. 3, a detection process starts with instruction 5100 to wake up the system with step 5112. When a sound or vibration transducer 110 detects a signal shown in step 5114, processing module 120 will enter step 5116 to see whether the signal is from a flowing liquid or gas. If the signal does not indicate a flow, the result is logged in the memory 140 and the process goes back to 5100. In the event that a flow is detected, a monitoring system of the present invention initiates a series of activities, including in 5118 starting to time of the flow for duration in 5118. In the meantime, 120 will produce a profile of the event in 5120, extract various signatures in 5122, and in steps 5124 and 5126 perform matching analysis of the extracted signature and profile with those in memory to reach decision point 5128. If a normal flow is positively identified, step 5136 is introduced to determine the situation when someone left a faucet on during a water outage.

A system can detect a water outage and return of water in a number of ways. One method is by detecting signals of air bubbles when water is turned on after an outage. Another method is by detection change of resonance in the empty sections of the pipes as water is filling up. A third method for detecting the return of water supply is to detect a dominant signal and signature associated with flow of liquid through the gating valve before other NE flow signal appear. A combination of the above methods is more effective in detecting a water outage and return of water.

If step 5128 deems a flow to be through a normal exit, such as a faucet; and if step of 5136 indicates someone just turned on a faucet, the system will return to 5100 and log the event in memory. On the other hand, if there had not been a water outage, this indicates someone had accidentally left a faucet on; the monitoring system goes into countdown mode in step 5138. The timing limit in 5130 is long, 400 seconds for instance and adjustable by a user because the flow is less likely to be damaging. 5138 takes timing information from 5118. During the countdown, 5134 will check to see if the flow stops before time limit. This will allow a person in the building to discover and turn the water off. If the flow stops before time limit, the system will log the event, and go back to 5100. If the flow continues beyond time limit, the process moves to step 5142 to give shut-off signal. This shut-down can save water and prevent possible damage if no one is in a building.

If step 5128 does not indicate that the signal represent a normal flow from the liquid infrastructure, step 5130 will further check to see if the signal matches abnormal flow signatures and profiles in memory 140 as shown in FIG. 1. If a signal matches an abnormal signature in memory, the process moves to step 5142 to give shut-off signal.

If a match does not happen, a monitoring system goes into countdown mode in step 5132. The timing limit in 5132 is short, 60 seconds for instance because the flow is not identifiable and likely damaging. 5132 takes timing information from 5118. During the countdown, 5134 will check to see if the flow stops before time limit. This will leave room for normal use that is not determined for certain reasons. If the flow stops before time limit, the system will log the event, store the new signature and go back to 5100. If the flow continues beyond time limit, the process moves to step 5142 to give shut-off signal.

The shut-off signals from 5142 will trigger a step 5160, which send an inquiry to the outside of the monitoring system, for instance, to a maintenance office to see whether detected leak is merely a new device connected by a construction crew.

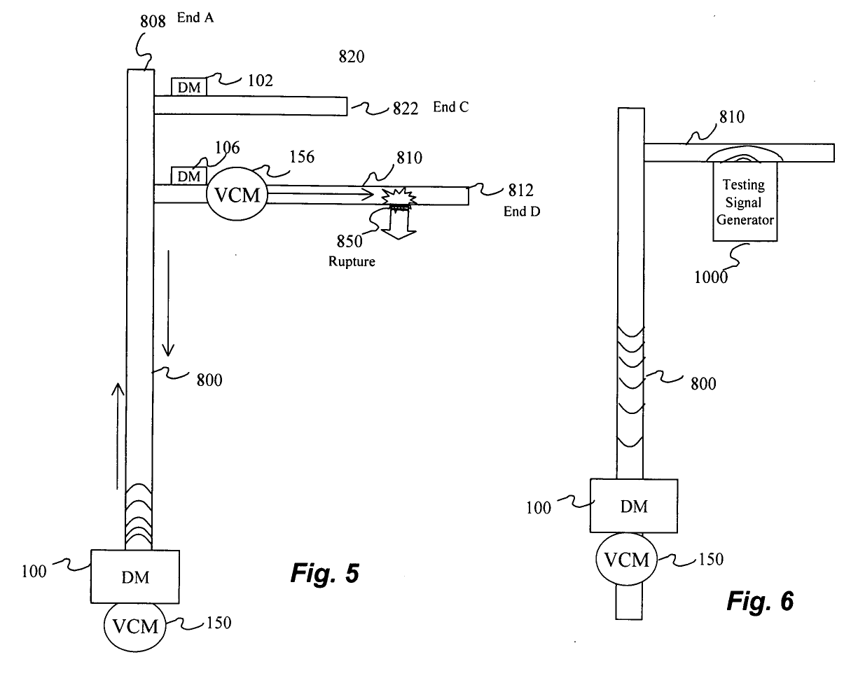

The shut-off signals from 5142 is passed onto step 5144, which checks various data from sources external to the a detection module executing the detection logic. For example, 5220 from other detection modules or devices as shown in FIG. 4, data 5240 including information such as human instruction in response to message sent out in step 5160, as well as data 5200 representing fire presence or sprinkler activation, and 5210 from other leak sensors. For example, if signal 5200 is present, it is an indication of fire and the activation of sprinklers. For residential building with sprinkler connected to municipal water supply, water must remain on to ensure the sprinkler's ability for protection against wire. Therefore, shut-off signal from 5142 is overridden during step 5146 by a 5200 indicating fire. The process returns to 5100 and the water will not be shut down. If the 5200 is not present, the 5144 will check the presence of other external inputs.

In another instance, if 5144 receives a signal from 5210, which confirm the present of leak as determined by the monitoring system with further information on the location of leak as in the proximity of sensor 5210. The process will proceed past 5146 to 5150 to activate shut-off.

There are incidences that both 5200 and 5210 are present during step 5144 during a fire because both leak sensor detects sprinkler activation sensor have detected water. In a system according to the present invention, a higher priority is assigned to 5200 over 5210 and the system overrides a shut-off command. This designation overcomes the conflict between 5200 and 5210 when both are received by 5144.

Data designated by 5220 includes a number of sources and types of data outputs from (1) other detection modules in a monitoring system with multiple detection modules, such as 102, 104 and 106 mounted on the same liquid carrying infrastructure 800 as shown in FIG. 4; (2) other detection modules mounted on the draining liquid infrastructure 900 down stream from the liquid carrying system 800 being monitored such as 108, shown in FIG. 4; (3) Temperature sensors such as 210 in FIG. 4.

As a first example for 5220, detection modules 100, 102, 104 and 106 shown in FIG. 4 are carrying out detection logic step 5144. 100, 102, 104 and 106 can communicate with each via modulated vibration and/or sound, over the pipe and water or WiFi over air, can compare detected vibration and sound signal strength from a possible leak 850. The concurrent execution of step 5144 in all four detection modules determines that 106, which detected the strongest signal indicating a leak 850 on section 810, should first proceed to step 5146 and 5150. The four detection modules, 100, 102, 104 and 106 will then further communicate after the shut-off by 156 to see if the leak is stopped. If not, 100 will proceed with shut-off instruction to 150.

As a second example for 5220, when 100 detect signal indicating a leak 850 and the process is at step 5144, if data from 108 on 900 as shown in FIG. 4 indicates no liquid flow in present in the sewer pipes, the certainty for a possible leak becomes higher. On the other hand, a vibration signal indicating the presence of flow 999 corresponding to a detection flow from 852 will most likely indicate a normal flow.

Similarly, if a leak is indicated in one section 810 of a liquid infrastructure but the signal indicating drainage from 108 on 900 which is not the sewer section for 810, the possibility of 850 being leak remain high. However, if a flow is indicated in one section 810 of a liquid infrastructure but the signal indicating drainage from 110 on 910, which is the sewer section for 810, the possibility of 850 being leak will be lowered. The system will decide whether to shut-off the system based on other information, such as whether a renovation have been underway, which introduces many new but temporary devices to the liquid infrastructure.

As a third example for 5220, if a temperature sensors 210 installed on a pipe detects freezing temperature in the past, the possibility of 850 being leak will be increased during analysis.

5240 represents data from sources that are useful in the detection process, including (1) calendar, day of month, day of week and time of day; (2) external human instructions sent over the internet, for example.

As a first example of 5240, the monitoring system of the present invention is capable of logging time stamped activities with their characteristics. These usage history logs then are stored in memory on or remote a detection module 100. The logs provides daily, weekly, monthly and annually usage pattern in a building that are useful when determining the likelihood a detected water flow to be normal use or a potentially damaging leak. Using both annual log and calendar of a building in northern hemisphere, for instance, a long duration water flow in the January is rare according to the history log and more likely to be a leak from a burst pipe. The log may show a lot of long duration water flow in July due to watering the lawn. The combination of these log data is most helpful for the detection model to determine a long duration flow occurred at a typically low usage time, for instance, late at night, during the day when people are way from home, or during the weekend when a school building is closed.

As a second example of 5240, the monitoring system of the present invention is capable of communicating with outside authorities with step 5160 after the shut-off is signaled by step 5142. The messages sent by 5160 are, for instance, brief reports of the detected water flow with location, start time, lapse time and estimated flow rate. This feature is most useful in a large building that maintenance personnel can use the information and tell a detection module 100 with data 5132 to hold off a valve shut-off since that may affect other urgent users. When the maintenance personnel give not response and the flow rate is high, the shut-off instruction will proceed to 5150.

Step 5150 is the actuation of valve mechanism to shut the valve off.

The step 5162 will send messages reporting the status of the valve along with location, start time, lapse time and estimated flow rate to (1) a visual display 310 shown in FIG. 4 with text or graphic information about the system being or having been shut-off, and/or possible leak as determined and/or likely locations of leak; (2) a security system 320 shown in FIG. 4 or monitoring service such as those provided commercially to report a detected leak in the building by a system of the present invention; (3) a system such as a speaker or alarm 330 shown in FIG. 4 that can produce alarm sound or speech messages warning of detected leaks or water shutting down. (4) the internet 400 that can distribute the message to a large number of recipients via devices such as a personal digital assistant (PDA) 410, a cell phone 420 or a personal computer 430 shown in FIG. 4.

FIG. 4 illustrates a comprehensive system of the present invention. As a result, depending on the size of the building, the sophistication of the system required, a monitoring system could be as simple as just the detection module 100 that monitors a building and report possible leaks. A system for monitoring pipes in large buildings comprises communication capability to send receive information with devices 410, 420 and 430 over internet 400, exchange data with other detection modules 102, 104, 106, 108 and 110, take inputs from sensors 210, 220 and 230, detect normal or abnormal flow events, determine possible leak 810 with advanced information such as location, starting time, time lapsed before shut-off, estimated rate and volume of leak to visual display 310, security system 320 and audio warning system 330 and control multiple valve control modules 150, 152 and 156 to shut-off individual section of the pipe infrastructure or to shut the whole infrastructure off. A detection module 100 can be made to be in separate housing as the valve control module 150 as certain situations may find the separation to be appropriate as shown.

It is to be noted that, for consistency of description and clarity of illustrations, this disclosure intentionally limits the examples of the present invention primarily using water pipe infrastructures in a building. It is to be emphasized that the present invention is applicable to gas pipe as well as liquid pipe infrastructures. In addition, vibration signatures from earthquakes and pipe rupturing by a quake can also enable a monitoring system in accordance with the present to shut off gas, gasoline or water supply when an earthquake occurs. Many ramifications are possible without departing from the principles of the present invention.

1. A device for detecting and control abnormal flow occurrences in a liquid or gas-carrying infrastructure comprises,
Power sources,
A sound and/or vibration transducer module, said transducers are coupled to an infrastructure being monitored,
A signal processing module with a mean to access digital profiles stored locally or in a remote location, and
A valve actuator module.

2. A device for detecting and determining the cause and nature of flow occurrences in a liquid or gas-carrying infrastructure comprises,
Power sources.
A sound and/or vibration transducer module, said transducers are coupled to an infrastructure being monitored,
A signal processing module with a mean to access digital profiles stored locally or in a remote location, and
An IP network addressable communication module.

3. Method for determining the cause and nature of flow occurrences in liquid or gas carrying infrastructures:
Detecting vibration and/or sound signals associated with a flow,
Processing said vibration signal to extract a digital profile,
Comparing said digital profile with stored digital profile associated with flow events.

4. Method for monitoring flow occurrences and determining the cause and nature of a flow event in a liquid or gas carrying infrastructure:
Detecting first vibration and/or sound signals associated with a flow,
Reading auxiliary data and information, including secondary vibration and/or sound signals,
Processing said first signal with auxiliary data and information.
